(19) United States
(12) Patent Application Publication
(10) Pub. No.: US 2023/0319715 A1
(43) Pub. Date: Oct. 5, 2023

(54) WAKE UP SIGNAL FOR SIDELINK DEVICE-TO-DEVICE COMMUNICATIONS

(71) Applicant: QUALCOMM Incorporated, San Diego, CA (US)

(72) Inventors: Nan ZHANG, Beijing (CN); Yongjun XU, Beijing (CN); Long HAN, Shanghai (CN)

(21) Appl. No.: 18/040,955

(22) PCT Filed: Oct. 2, 2020
(86) PCT No.: PCT/CN2020/119779

§ 371 Date: Feb. 7, 2023

(51) Int. Cl. H04W 52/02; H04W 76/28; H04W 68/02

(52) U.S. Cl. CPC H04W 52/0229; H04W 76/28; H04W 68/02

(57) ABSTRACT

Various aspects of the present disclosure generally relate to wireless communication. In some aspects, a first user equipment (UE) may transmit, to a second UE, an indication of a discontinuous reception paging cycle and a wake up signal time offset value. The UE may transmit, to the second UE, a wake up signal based at least in part on the discontinuous reception paging cycle and the wake up signal time offset value. Numerous other aspects are provided.

### FIELD OF THE DISCLOSURE

Aspects of the present disclosure generally relate to wireless communication and to techniques and apparatuses for wake up signaling for sidelink device-to-device communications.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a first UE includes transmitting, to a second UE, an indication of a discontinuous reception paging cycle and a wake up signal time offset value; and transmitting, to the second UE, a wake up signal based at least in part on the discontinuous reception paging cycle and the wake up signal time offset value.

In some aspects, a method of wireless communication performed by a second UE includes receiving, from a first UE, an indication of a discontinuous reception paging cycle and a wake up signal time offset value; and receiving, from the first UE, a wake up signal based at least in part on the discontinuous reception paging cycle and the wake up signal time offset value.

In some aspects, a first UE for wireless communication includes a memory and one or more processors operatively coupled to the memory, the memory and the one or more processors configured to: transmit, to a second UE, an indication of a discontinuous reception paging cycle and a wake up signal time offset value; and transmit, to the second UE, a wake up signal based at least in part on the discontinuous reception paging cycle and the wake up signal time offset value.

In some aspects, a second UE for wireless communication includes a memory and one or more processors operatively coupled to the memory, the memory and the one or more processors configured to: receive, from a first UE, an indication of a discontinuous reception paging cycle and a wake up signal time offset value; and receive, from the first UE, a wake up signal based at least in part on the discontinuous reception paging cycle and the wake up signal time offset value.

In some aspects, a non-transitory computer-readable medium storing a set of instructions for wireless communication includes one or more instructions that, when executed by one or more processors of a first UE, cause the UE to: transmit, to a second UE, an indication of a discontinuous reception paging cycle and a wake up signal time offset value; and transmit, to the second UE, a wake up signal based at least in part on the discontinuous reception paging cycle and the wake up signal time offset value.

In some aspects, a non-transitory computer-readable medium storing a set of instructions for wireless communication includes one or more instructions that, when executed by one or more processors of a second UE, cause the UE to: receive, from a first UE, an indication of a discontinuous reception paging cycle and a wake up signal time offset value; and receive, from the first UE, a wake up signal based at least in part on the discontinuous reception paging cycle and the wake up signal time offset value.

In some aspects, an apparatus for wireless communication includes means for transmitting, to a second UE, an indication of a discontinuous reception paging cycle and a wake up signal time offset value; and means for transmitting, to the second UE, a wake up signal based at least in part on the discontinuous reception paging cycle and the wake up signal time offset value.

In some aspects, an apparatus for wireless communication includes means for receiving, from a first UE, an indication of a discontinuous reception paging cycle and a wake up signal time offset value; and means for receiving, from the first UE, a wake up signal based at least in part on the discontinuous reception paging cycle and the wake up signal time offset value.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with various aspects of the present disclosure.

FIG. 2 is a diagram illustrating an example of a base station in communication with a UE in a wireless network, in accordance with various aspects of the present disclosure.

FIG. 3 is a diagram illustrating an example of sidelink communications, in accordance with various aspects of the present disclosure.

FIG. 4 is a diagram illustrating an example of sidelink communications and access link communications, in accordance with various aspects of the present disclosure.

FIG. 5 is a diagram illustrating an example of a discontinuous reception (DRX) configuration, in accordance with various aspects of the present disclosure.

FIG. 6 is a diagram illustrating an example associated with wake up signaling for sidelink device-to-device communications, in accordance with various aspects of the present disclosure.

FIGS. 7-8 are diagrams illustrating example processes associated with wake up signaling for sidelink device-to-device communications, in accordance with various aspects of the present disclosure.

FIG. 9 is a block diagram of an example apparatus for wireless communication, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

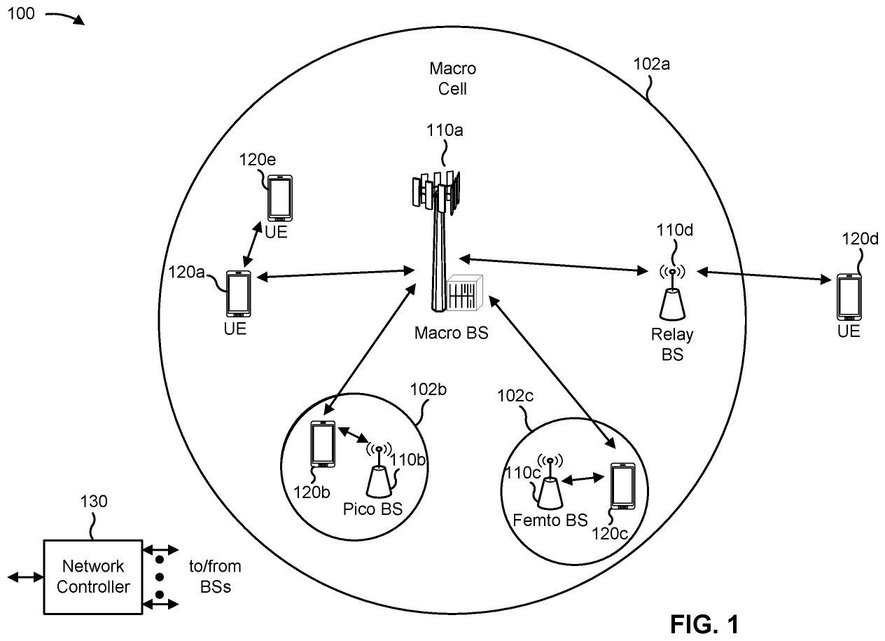

FIG. 1 is a diagram illustrating an example of a wireless network 100, in accordance with various aspects of the present disclosure. The wireless network 100 may be or may include elements of a 5G (NR) network, an LTE network, and/or the like. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. ABS for a pico cell may be referred to as a pico BS. ABS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components, memory components, and/or the like. In some aspects, the processor components and the memory components may be coupled together. For example, the processor components (e.g., one or more processors) and the memory components (e.g., a memory) may be operatively coupled, communicatively coupled, electronically coupled, electrically coupled, and/or the like.

In general, any number of wireless networks may be deployed in a given geographic area. Each wireless network may support a particular RAT and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V21) protocol, and/or the like), a mesh network, and/or the like. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, and/or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

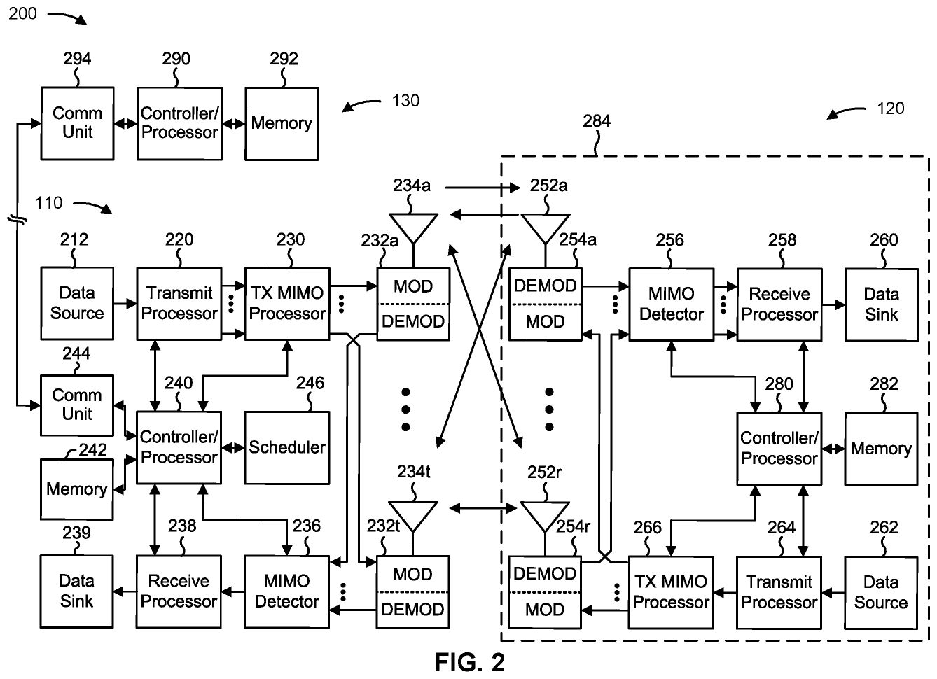

FIG. 2 is a diagram illustrating an example 200 of a base station 110 in communication with a UE 120 in a wireless network 100, in accordance with various aspects of the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., a cell-specific reference signal (CRS), a demodulation reference signal (DMRS), and/or the like) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

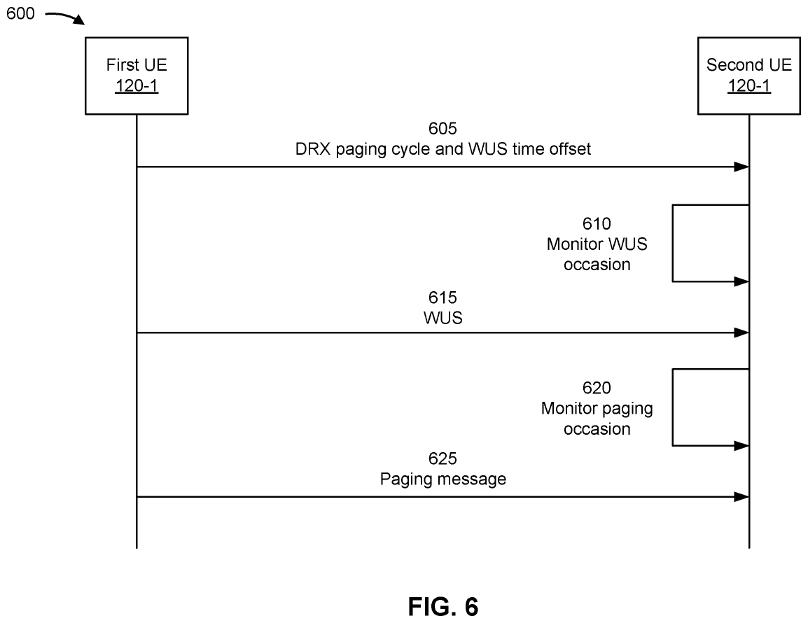

On the uplink, at UE 120, a transmit processor 264 may receive and process data from a data source 262 and control information (e.g., for reports that include RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein, for example, as described with reference to FIGS. 6-8.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein, for example, as described with reference to FIGS. 6-8.

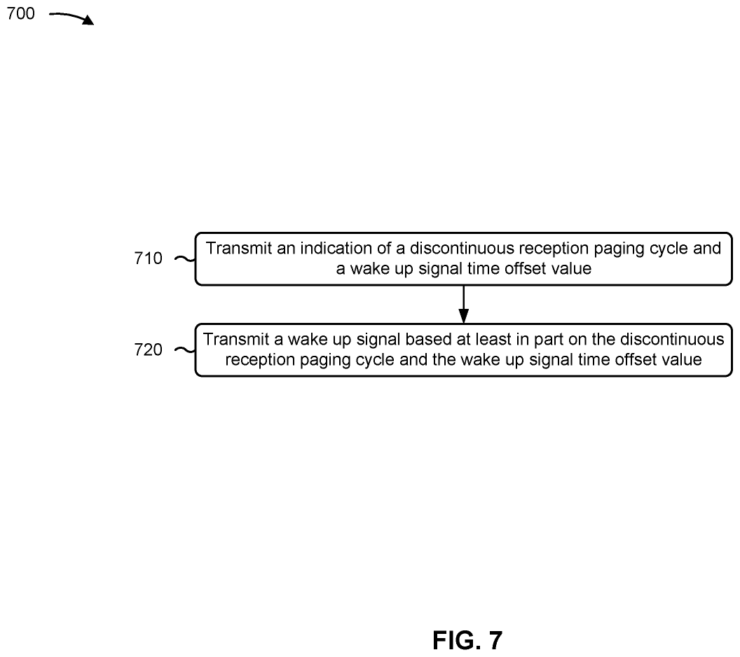

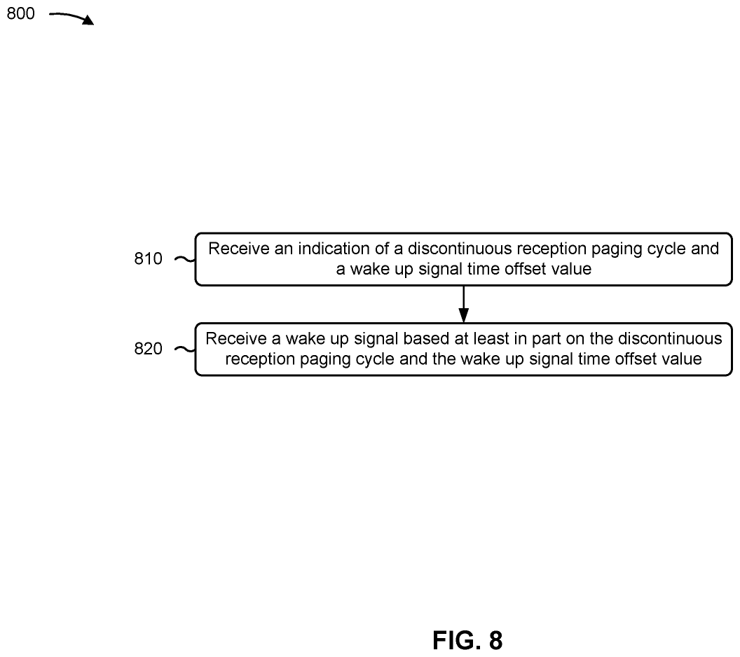

Controller/processor 240 of base station 110, controller/processor 280 of UE 120, and/or any other component(s) of FIG. 2 may perform one or more techniques associated with wake up signaling for sidelink device-to-device communications, as described in more detail elsewhere herein. For example, controller/processor 240 of base station 110, controller/processor 280 of UE 120, and/or any other component(s) of FIG. 2 may perform or direct operations of, for example, process 700 of FIG. 7, process 800 of FIG. 8, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code, program code, and/or the like) for wireless communication. For example, the one or more instructions, when executed (e.g., directly, or after compiling, converting, interpreting, and/or the like) by one or more processors of the base station 110 and/or the UE 120, may cause the one or more processors, the UE 120, and/or the base station 110 to perform or direct operations of, for example, process 700 of FIG. 7, process 800 of FIG. 8, and/or other processes as described herein. In some aspects, executing instructions may include running the instructions, converting the instructions, compiling the instructions, interpreting the instructions, and/or the like.

In some aspects, the UE includes means for transmitting, to a second UE, an indication of a discontinuous reception paging cycle and a wake up signal time offset value; and/or means for transmitting, to the second UE, a wake up signal based at least in part on the discontinuous reception paging cycle and the wake up signal time offset value. The means for the UE to perform operations described herein may include, for example, antenna 252, demodulator 254, MIMO detector 256, receive processor 258, transmit processor 264, TX MIMO processor 266, modulator 254, controller/processor 280, and/or memory 282.

In some aspects, the UE includes means for transmitting the wake up signal using beam sweeping in a plurality of beam directions. In some aspects, the UE includes means for transmitting the wake up signal in a wake up signal occasion preceding a paging occasion in the discontinuous reception paging cycle based at least in part on the wake up signal offset value. In some aspects, the UE includes means for transmitting, to the second UE, a paging message based at least in part on transmitting the wake up signal. In some aspects, the UE includes means for transmitting the paging message in a paging occasion in the discontinuous reception paging cycle subsequent to transmitting the wake up signal, based at least in part on the wake up signal time offset value. In some aspects, the UE includes means for transmitting the paging message using beam sweeping in a plurality of beam directions. In some aspects, the UE includes means for transmitting the wake up signal to the second UE while the second UE is in at least one of an idle mode or an inactive mode.

In some aspects, the UE includes means for receiving, from a first UE, an indication of a discontinuous reception paging cycle and a wake up signal time offset value; and/or means for receiving, from the first UE, a wake up signal based at least in part on the discontinuous reception paging cycle and the wake up signal time offset value. The means for the UE to perform operations described herein may include, for example, antenna 252, demodulator 254, MIMO detector 256, receive processor 258, transmit processor 264, TX MIMO processor 266, modulator 254, controller/processor 280, and/or memory 282.

In some aspects, the UE includes means for monitoring a wake up signal occasion preceding a paging occasion in the discontinuous reception paging cycle based at least in part on the wake up signal offset value; and/or means for receiving, from the first UE, the wake up signal in the wake up signal occasion. In some aspects, the UE includes means for activating from a sleep state to monitor the wake up signal occasion. In some aspects, the UE includes means for monitoring the paging occasion subsequent to the wake up signal occasion based at least in part on receiving the wake up signal in the wake up signal occasion. In some aspects, the UE includes means for receiving, from the first UE, a paging message in the paging occasion subsequent to the wake up signal occasion. In some aspects, the UE includes means for switching from one of an idle mode or an inactive mode to a connected mode based at least in part on receiving the paging message.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

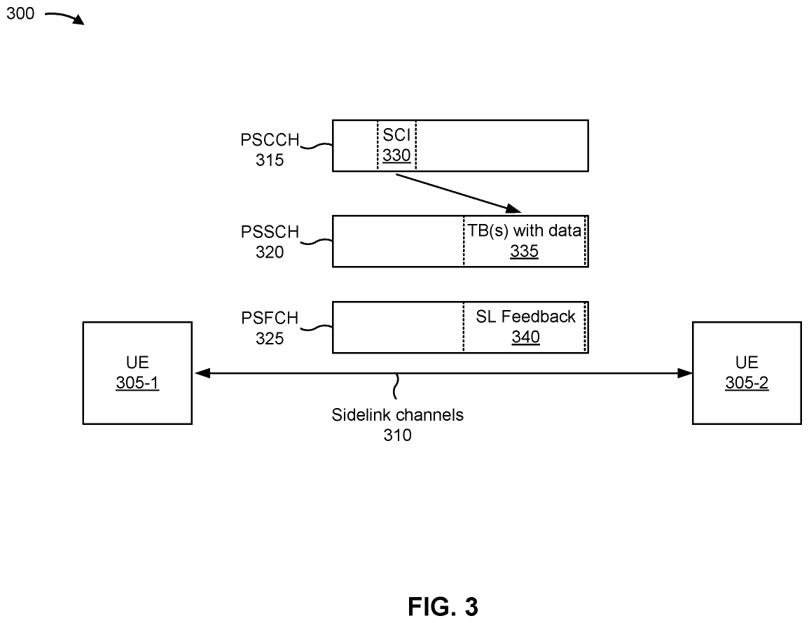

FIG. 3 is a diagram illustrating an example 300 of sidelink communications, in accordance with various aspects of the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, vehicle to pedestrian (V2P) communications, and/or the like), mesh networking, and/or the like. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, symbols, and/or the like) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a base station 110 via an access link or an access channel. The PSSCH 320 may be used to communicate data, similar to a physical downlink shared channel (PDSCH) and/or a physical uplink shared channel (PUSCH) used for cellular communications with a base station 110 via an access link or an access channel. For example, the PSCCH 315 may carry sidelink control information (SCI) 330, which may indicate various control information used for sidelink communications, such as one or more resources (e.g., time resources, frequency resources, spatial resources, and/or the like) where a transport block (TB) 335 may be carried on the PSSCH 320. The TB 335 may include data. The PSFCH 325 may be used to communicate sidelink feedback 340, such as hybrid automatic repeat request (HARD) feedback (e.g., acknowledgement or negative acknowledgement (ACK/NACK) information), transmit power control (TPC), a scheduling request (SR), and/or the like.

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a transmission mode where resource selection and/or scheduling is performed by the UE 305 (e.g., rather than a base station 110). In some aspects, the UE 305 may perform resource selection and/or scheduling by sensing channel availability for transmissions. For example, the UE 305 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, may measure a reference signal received quality (RSRQ) parameter (e.g., a PSSCH-RSRQ parameter) associated with various sidelink channels, and/or the like, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources, channel parameters, and/or the like. Additionally, or alternatively, the UE 305 may perform resource selection and/or scheduling by determining a channel busy rate (CBR) associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, a modulation and coding scheme (MCS) to be used for the upcoming sidelink transmission, and/or the like. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

As indicated above, FIG. 3 is provided as an example. Other examples may differ from what is described with respect to FIG. 3.

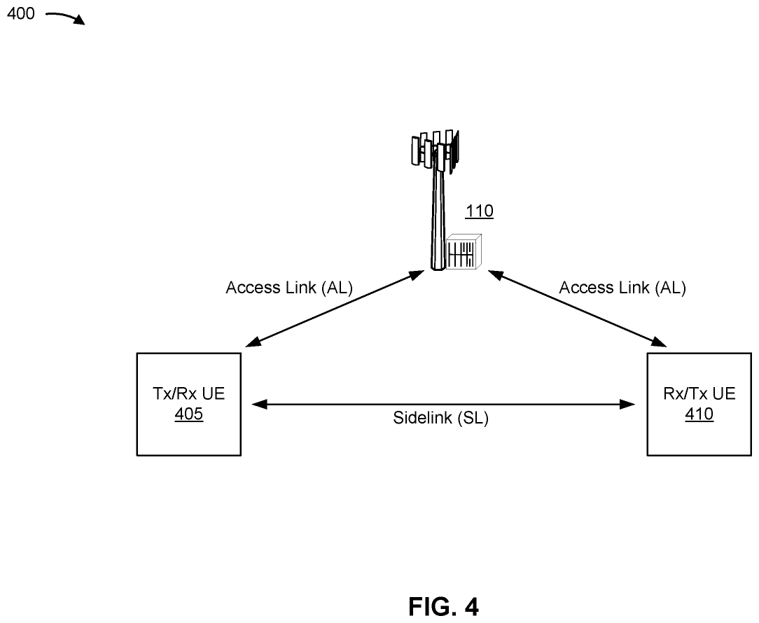

FIG. 4 is a diagram illustrating an example 400 of sidelink communications and access link communications, in accordance with various aspects of the present disclosure.

As shown in FIG. 4, a transmitter (Tx)/receiver (Rx) UE 405 and an Rx/Tx UE 410 may communicate with one another via a sidelink, as described above in connection with FIG. 3. As further shown, in some sidelink modes, a base station 110 may communicate with the Tx/Rx UE 405 via a first access link. Additionally, or alternatively, in some sidelink modes, the base station 110 may communicate with the Rx/Tx UE 410 via a second access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a base station 110 and a UE 120 (e.g., via a Uu interface) may be referred to as an access link. Sidelink communications may be transmitted via the sidelink, and access link communications may be transmitted via the access link. An access link communication may be either a downlink communication (from a base station 110 to a UE 120) or an uplink communication (from a UE 120 to a base station 110).

As indicated above, FIG. 4 is provided as an example. Other examples may differ from what is described with respect to FIG. 4.

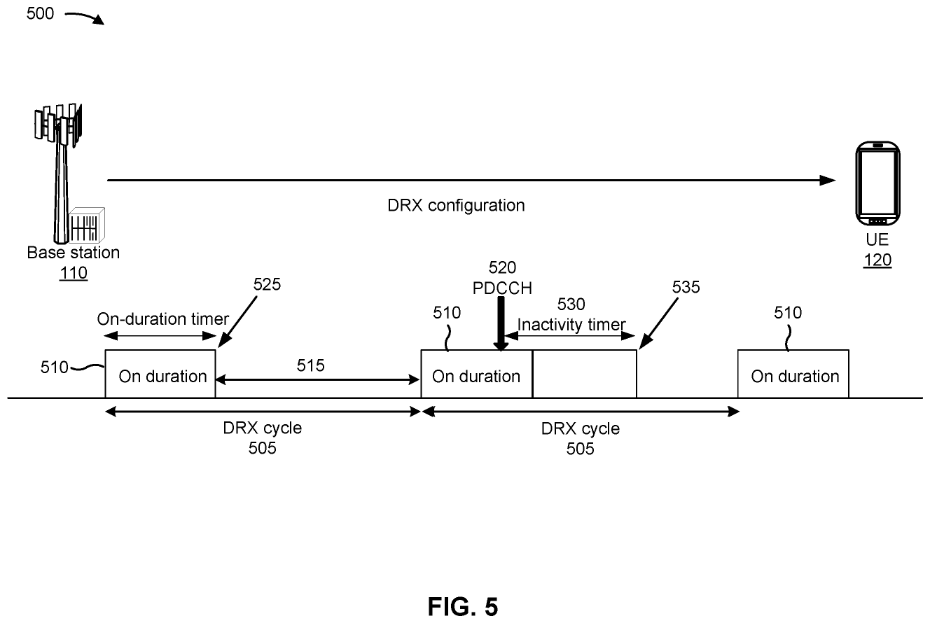

FIG. 5 is a diagram illustrating an example 500 of a discontinuous reception (DRX) configuration, in accordance with various aspects of the present disclosure.

As shown in FIG. 5, a base station 110 may transmit a DRX configuration to a UE 120 to configure a DRX cycle 505 for the UE 120. A DRX cycle 505 may include a DRX on duration 510 (e.g., during which a UE 120 is awake or in an active state) and an opportunity to enter a DRX sleep state 515. As used herein, the time during which the UE 120 is configured to be in an active state during the DRX on duration 510 may be referred to as an active time, and the time during which the UE 120 is configured to be in the DRX sleep state 515 may be referred to as an inactive time. As described below, the UE 120 may monitor a PDCCH during the active time, and the UE 120 may refrain from monitoring the PDCCH during the inactive time.

During the DRX on duration 510 (e.g., the active time), the UE 120 may monitor a downlink control channel (e.g., a PDCCH), as shown by reference number 520. For example, the UE 120 may monitor the PDCCH for downlink control information (DCI) pertaining to the UE 120. If the UE 120 does not detect and/or successfully decode any PDCCH communications intended for the UE 120 during the DRX on duration 510, then the UE 120 may enter the sleep state 515 (e.g., for the inactive time) at the end of the DRX on duration 510, as shown by reference number 525. In this way, the UE 120 may conserve battery power and reduce power consumption. As shown, the DRX cycle 505 may repeat with a configured periodicity according to the DRX configuration.

If the UE 120 detects and/or successfully decodes a PDCCH communication intended for the UE 120, then the UE 120 may remain in an active state (e.g., awake) for the duration of a DRX inactivity timer 530 (e.g., which may extend the active time). The UE 120 may start the DRX inactivity timer 530 at a time at which the PDCCH communication is received (e.g., in a transmission time interval (TTI) in which the PDCCH communication is received, such as a slot, a subframe, and/or the like). The UE 120 may remain in the active state until the DRX inactivity timer 530 expires, at which time the UE 120 may enter the sleep state 515 (e.g., for the inactive time), as shown by reference number 535. During the duration of the DRX inactivity timer 530, the UE 120 may continue to monitor for PDCCH communications, may obtain a downlink data communication (e.g., on a downlink data channel, such as a physical downlink shared channel (PDSCH)) scheduled by the PDCCH communication, may prepare and/or transmit an uplink communication (e.g., on a physical uplink shared channel (PUSCH)) scheduled by the PDCCH communication, and/or the like. The UE 120 may restart the DRX inactivity timer 530 after each detection of a PDCCH communication for the UE 120 for an initial transmission (e.g., but not for a retransmission). By operating in this manner, the UE 120 may conserve battery power and reduce power consumption by entering the sleep state 515.

As indicated above, FIG. 5 is provided as an example. Other examples may differ from what is described with respect to FIG. 5.

When a UE is in a radio resource control (RRC) idle or inactive mode, a base station may page the UE with paging messages to inform the UE that there is an incoming connection request or system information update. The UE may be configured to use a DRX cycle in the RRC idle or inactive mode to monitor the PDCCH for the paging messages. In this case, the DRX On durations (e.g., active times) may correspond to paging occasions in which the base station transmits the paging messages. During a DRX On duration (e.g., active time), the UE may wake up from the sleep state and monitor the PDCCH for a paging message targeting the UE. For example, the UE may decode DCI in a PDCCH communication to determine if the paging message targets the UE.

In 5G/NR, the base station may transmit a wake up signal (WUS) to the UE prior to a paging occasion in which the UE is paged. In this case, during a DRX On duration (e.g., active time), the UE may wake from the sleep state and determine whether the WUS is detected. If the WUS is not detected, the UE may return to the sleep state. If the WUS is detected, the UE may monitor the PDCCH for a paging message in the subsequent paging occasion. Thus, the UE only needs to monitor and decode a PDCCH communication in the paging occasion if the WUS is detected in the WUS occasion. This results in reduced power consumption by the UE in the RRC idle or inactive mode.

In sidelink device-to-device (D2D) communications, a first UE (e.g., a TX UE) may send paging messages to a second UE (e.g., an RX UE) when the second UE is in an idle or inactive mode. However, a WUS is not currently used in beam-based 5G/NR sidelink communications. Sidelink D2D paging monitoring may consume a large amount of power and cause reduced battery life for UEs, particularly in the case of non-V2X UEs, such as smartphones, massive MTC (mMTC) type UEs, and/or the like.

Some techniques and apparatuses described herein enable a first UE to transmit, to a second UE an indication of a DRX paging cycle and a WUS time offset value, and transmit, to the second UE, a WUS based at least in part on the DRX paging cycle and the WUS time offset value. The second UE may monitor for the WUS based at least in part on the DRX paging cycle and the WUS time offset value, and monitor a paging occasion subsequent to the WUS based at least in part on receiving the WUS. As a result, UE power consumption associated with sidelink D2D paging may be reduced as compared with sidelink D2D paging monitoring without a WUS. Thus, UE battery life may be increased, particularly for non-V2X UEs, such as smartphones, mMTC type UEs, and/or the like.

FIG. 6 is a diagram illustrating an example 600 associated with wake up signaling for sidelink D2D communications, in accordance with various aspects of the present disclosure. As shown in FIG. 6, example 600 includes communication between a first UE 120-1 and a second UE 120-2. In some aspects, the first UE 120-1 and the second UE 120-2 may be included in a wireless network, such as wireless network 100. The first UE 120-1 and the second UE 120-2 may perform D2D communications on a sidelink. The first UE 120-1 may be a Tx UE and the second UE 120-2 may be an Rx UE, or the first UE 120-1 may be an Rx UE and the second UE 120-2 may be a Tx UE.

As shown in FIG. 6, and by reference number 605, the first UE 120-1 may transmit, to the second UE 120-2, an indication of a DRX paging cycle and a WUS time offset value. In some aspects, the indication of the DRX paging cycle and the WUS time offset value may be included in a DRX configuration transmitted from the first UE 120-1 to the second UE 120-2 to configure the DRX paging cycle for the second UE 120-2. For example, the indication of the DRX paging cycle and the WUS time offset value may be included in an RRC communication. Additionally, and/or alternatively, the indication of the DRX paging cycle and the WUS time offset value may be included in a medium access control (MAC) control element (MAC-CE) and/or control information (e.g., SCI), among other examples. The first UE 120-1 may transmit the indication of the DRX paging cycle and the WUS time offset value while the second UE 120-2 is in a connected mode (e.g., RRC connected mode).

The DRX paging cycle may include one or more paging occasions during which paging messages may be transmitted from the first UE 120-1 to the second UE 120-2. The WUS time offset value may indicate a time offset for a respective WUS occasion prior to each paging occasion. That is, the WUS time offset value may indicate a time, prior to a paging occasion, at which the second UE 120-2 is to monitor for a WUS from the first UE 120-1.

As further shown in FIG. 6, and by reference number 610, the second UE 120-2 may monitor a WUS occasion based at least in part on the DRX paging cycle and the WUS time offset value. As described above, the DRX paging cycle may include one or more paging occasions, and the WUS time offset value may define a respective WUS occasion preceding each paging occasion. While in an idle mode (e.g., RRC idle mode) or an inactive mode (e.g., RRC inactive mode), the second UE 120-2 may monitor each WUS occasion to detect whether a WUS is received in that WUS occasion. While in the idle mode or the inactive mode, the second UE 120-2 may activate from a sleep state to an active state (e.g., DRX On) to monitor each WUS occasion.

As further shown in FIG. 6, and by reference number 615, the first UE 120-1 may transmit a WUS to the second UE 120-2 during a WUS occasion based at least in part on the DRX paging cycle and the WUS time offset value. The first UE 120-1 may transmit the WUS to the second UE 120-2 during a WUS occasion preceding a paging occasion in which a paging message is to be transmitted to the second UE 120-2. In some aspects, the first UE 120-1 may transmit the WUS using beam sweeping in multiple beam directions. For example, the first UE 120-1 may transmit the WUS using beam sweeping in all TX beam directions or a subset of TX beam directions.

While in the idle mode or inactive mode, the second UE 120-2 may activate from the sleep state to the active state (e.g., DRX On) to monitor the WUS occasion, and may receive the WUS transmitted by the first UE 120-1 while monitoring the WUS.

As further shown in FIG. 6, and by reference number 620, the second UE 120-2 may monitor a paging occasion based at least in part on receiving the WUS. The second UE 120-2 may monitor the paging occasion subsequent to the WUS occasion in which the WUS is received. During the paging occasion, the second UE 120-2 may monitor a physical control channel (e.g., PSCCH) for a paging message transmitted by the first UE 120-1.

As described above, the second UE 120-2 may activate from the sleep state to the active state (e.g., DRX On) to monitor each WUS occasion. As shown in example 600 of FIG. 6, when the second UE 120-2 receives a WUS in a WUS occasion, the second UE 120-2 may remain in the active state (e.g., DRX On) to monitor the subsequent paging occasion for a paging message. When the second UE 120-2 does not receive a WUS in a WUS occasion, the second UE 120-2 may return to the sleep state and may not monitor the subsequent paging occasion.

As further shown in FIG. 6, and by reference number 625, the first UE 120-1 may transmit a paging message to the second UE 120-2. The first UE 120-1 may transmit the paging message to the second UE 120-2 during the subsequent paging occasion to the WUS occasion in which the WUS is transmitted. In some aspects, the first UE 120-1 may transmit the paging message using beam sweeping in multiple beam directions. For example, the first UE 120-1 may transmit the paging message using beam sweeping in all Tx beam directions or a subset of Tx beam directions. In some aspects, the paging message may be included in a physical control channel (e.g., PSCCH) communication.

The second UE 120-2 may monitor the paging occasion based at least in part on receiving the WUS in the preceding WUS occasion, and the second UE 120-2 may receive the paging message while monitoring the paging occasion. The second UE 120-2 may receive a physical control channel communication including the paging message. The second UE 120-2 may decode the physical control channel communication and determine whether the second UE 120-2 is targeted by the paging message. For example, the second UE 120-2 may determine whether the paging message includes an identifier associated with the second UE 120-2. The second UE 120-2 may switch from the idle mode (e.g., RRC idle mode) or the inactive mode (e.g., RRC inactive mode) to a connected mode (e.g., RRC connected mode) based at least in part on receiving the paging message. For example, the second UE 120-2 may switch from the idle mode or the inactive mode to the connected mode based at least in part on a determination that the second UE 120-2 is targeted by the paging message. Once the second UE 120-2 switches to the connected mode, the second UE 120-2 may receive data from the first UE 120-1 and/or transmit data to the first UE 120-1.

As described above in connection with FIG. 6, the first UE 120-1 may transmit, to the second UE 120-2 an indication of a DRX paging cycle and a WUS time offset value, and transmit, to the second UE 120-2, a WUS based at least in part on the DRX paging cycle and the WUS time offset value. The second UE 120-2 may monitor for the WUS based at least in part on the DRX paging cycle and the WUS time offset value, and the second UE 120-2 may monitor a paging occasion subsequent to the WUS based at least in part on receiving the WUS. As a result, UE power consumption associated with sidelink D2D paging may be reduced as compared with sidelink D2D paging monitoring without a WUS.

As indicated above, FIG. 6 is provided as an example. Other examples may differ from what is described with respect to FIG. 6.

FIG. 7 is a diagram illustrating an example process 700 performed, for example, by a first UE, in accordance with various aspects of the present disclosure. Example process 700 is an example where the first UE (e.g., UE 120) performs operations associated with wake up signaling for sidelink D2D communications.

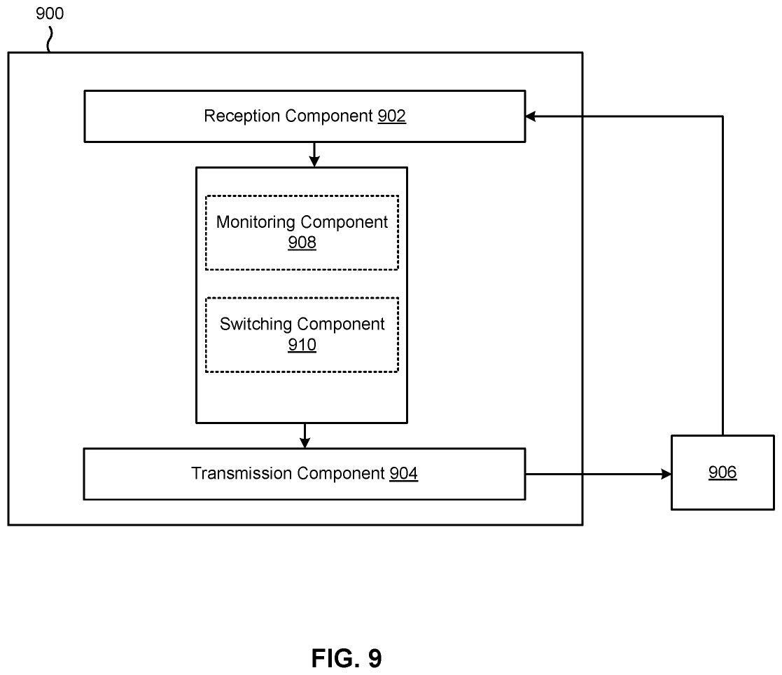

As shown in FIG. 7, in some aspects, process 700 may include transmitting, to a second UE, an indication of a discontinuous reception paging cycle and a wake up signal time offset value (block 710). For example, the first UE (e.g., using transmission component 904, depicted in FIG. 9) may transmit, to a second UE, an indication of a discontinuous reception paging cycle and a wake up signal time offset value, as described above.

As further shown in FIG. 7, in some aspects, process 700 may include transmitting, to the second UE, a wake up signal based at least in part on the discontinuous reception paging cycle and the wake up signal time offset value (block 720). For example, the first UE (e.g., using transmission component 904, depicted in FIG. 9) may transmit, to the second UE, a wake up signal based at least in part on the discontinuous reception paging cycle and the wake up signal time offset value, as described above.

Process 700 may include additional aspects, such as any single aspect or any combination of aspects described below and/or in connection with one or more other processes described elsewhere herein.

In a first aspect, the discontinuous reception paging cycle includes one or more paging occasions, and the wake up signal time offset value indicates a time offset for a wake up signal occasion prior to each paging occasion.

In a second aspect, alone or in combination with the first aspect, transmitting, to the second UE, a wake up signal based at least in part on the discontinuous reception paging cycle and the wake up signal time offset value comprises transmitting the wake up signal using beam sweeping in a plurality of beam directions.

In a third aspect, alone or in combination with one or more of the first and second aspects, process 700 includes transmitting the wake up signal in a wake up signal occasion preceding a paging occasion in the discontinuous reception paging cycle based at least in part on the wake up signal offset value.

In a fourth aspect, alone or in combination with one or more of the first through third aspects, process 700 includes transmitting, to the second UE, a paging message based at least in part on transmitting the wake up signal.

In a fifth aspect, alone or in combination with one or more of the first through fourth aspects, transmitting, to the second UE, the paging message based at least in part on transmitting the wake up signal comprises transmitting the paging message in a paging occasion in the discontinuous reception paging cycle subsequent to transmitting the wake up signal, based at least in part on the wake up signal time offset value.

In a sixth aspect, alone or in combination with one or more of the first through fifth aspects, transmitting, to the second UE, the paging message based at least in part on transmitting the wake up signal comprises transmitting the paging message using beam sweeping in a plurality of beam directions.

In a seventh aspect, alone or in combination with one or more of the first through sixth aspects, the paging message is included in a physical control channel communication.

In an eighth aspect, alone or in combination with one or more of the first through seventh aspects, transmitting the wake up signal comprises transmitting the wake up signal to the second UE while the second UE is in at least one of an idle mode or an inactive mode.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a second UE, in accordance with various aspects of the present disclosure. Example process 800 is an example where the second UE (e.g., UE 120) performs operations associated with wake up signaling for sidelink D2D communications.

As shown in FIG. 8, in some aspects, process 800 may include receiving, from a first UE, an indication of a discontinuous reception paging cycle and a wake up signal time offset value (block 810). For example, the second UE (e.g., using reception component 902, depicted in FIG. 9) may receive, from a first UE, an indication of a discontinuous reception paging cycle and a wake up signal time offset value, as described above.

As further shown in FIG. 8, in some aspects, process 800 may include receiving, from the first UE, a wake up signal based at least in part on the discontinuous reception paging cycle and the wake up signal time offset value (block 820). For example, the second UE (e.g., using reception component 902, depicted in FIG. 9) may receive, from the first UE, a wake up signal based at least in part on the discontinuous reception paging cycle and the wake up signal time offset value, as described above.

Process 800 may include additional aspects, such as any single aspect or any combination of aspects described below and/or in connection with one or more other processes described elsewhere herein.

In a first aspect, the discontinuous reception paging cycle includes one or more paging occasions, and the wake up signal time offset value indicates a time offset for a wake up signal occasion prior to each paging occasion.

In a second aspect, alone or in combination with the first aspect, the wake up signal is transmitted using beam sweeping in a plurality of beam directions.

In a third aspect, alone or in combination with one or more of the first and second aspects, process 800 includes monitoring a wake up signal occasion preceding a paging occasion in the discontinuous reception paging cycle based at least in part on the wake up signal offset value, and receiving, from the first UE, the wake up signal in the wake up signal occasion.

In a fourth aspect, alone or in combination with one or more of the first through third aspects, monitoring the wake up signal occasion comprises activating from a sleep state to monitor the wake up signal occasion.

In a fifth aspect, alone or in combination with one or more of the first through fourth aspects, process 800 includes monitoring the paging occasion subsequent to the wake up signal occasion based at least in part on receiving the wake up signal in the wake up signal occasion.

In a sixth aspect, alone or in combination with one or more of the first through fifth aspects, process 800 includes receiving, from the first UE, a paging message in the paging occasion subsequent to the wake up signal occasion.

In a seventh aspect, alone or in combination with one or more of the first through sixth aspects, the paging message is transmitted using beam sweeping in a plurality of beam directions.

In an eighth aspect, alone or in combination with one or more of the first through seventh aspects, the paging message is included in a physical control channel communication.

In a ninth aspect, alone or in combination with one or more of the first through eighth aspects, process 800 includes switching from one of an idle mode or an inactive mode to a connected mode based at least in part on receiving the paging message.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a block diagram of an example apparatus 900 for wireless communication. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include one or more of a monitoring component 908 or a switching component 910, among other examples.

In some aspects, the apparatus 900 may be configured to perform one or more operations described herein in connection with FIG. 6. Additionally, or alternatively, the apparatus 900 may be configured to perform one or more processes described herein, such as process 700 of FIG. 7, process 800 of FIG. 8, or a combination thereof. In some aspects, the apparatus 900 and/or one or more components shown in FIG. 9 may include one or more components of the UE described above in connection with FIG. 2. Additionally, or alternatively, one or more components shown in FIG. 9 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 906. In some aspects, the reception component 902 may include one or more antennas, a demodulator, a MIMO detector, a receive processor, a controller/processor, a memory, or a combination thereof, of the UE described above in connection with FIG. 2.

The transmission component 904 may transmit communications, such as reference signals, control information, data communications, or a combination thereof, to the apparatus 906. In some aspects, one or more other components of the apparatus 906 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modulator, a transmit MIMO processor, a transmit processor, a controller/processor, a memory, or a combination thereof, of the UE described above in connection with FIG. 2. In some aspects, the transmission component 904 may be collocated with the reception component 902 in a transceiver.

The transmission component 904 may transmit, to a second UE, an indication of a discontinuous reception paging cycle and a wake up signal time offset value. The transmission component 904 may transmit, to the second UE, a wake up signal based at least in part on the discontinuous reception paging cycle and the wake up signal time offset value.

The transmission component 904 may transmit the wake up signal in a wake up signal occasion preceding a paging occasion in the discontinuous reception paging cycle based at least in part on the wake up signal offset value.

The transmission component 904 may transmit, to the second UE, a paging message based at least in part on transmitting the wake up signal.

The reception component 902 may receive, from a first UE, an indication of a discontinuous reception paging cycle and a wake up signal time offset value. The reception component 902 may receive, from the first UE, a wake up signal based at least in part on the discontinuous reception paging cycle and the wake up signal time offset value.

The monitoring component 908 may monitor a wake up signal occasion preceding a paging occasion in the discontinuous reception paging cycle based at least in part on the wake up signal offset value. In some aspects, the monitoring component 908 may include one or more antennas, a demodulator, a MIMO detector, a receive processor, a controller/processor, a memory, or a combination thereof, of the UE described above in connection with FIG. 2.

The reception component 902 may receive, from the first UE, the wake up signal in the wake up signal occasion.

The monitoring component 908 may monitor the paging occasion subsequent to the wake up signal occasion based at least in part on receiving the wake up signal in the wake up signal occasion.

The reception component 902 may receive, from the first UE, a paging message in the paging occasion subsequent to the wake up signal occasion.

The switching component 910 may switch from one of an idle mode or an inactive mode to a connected mode based at least in part on receiving the paging message. In some aspects, the switching component 910 may include one or more antennas, a demodulator, a MIMO detector, a receive processor, a modulator, a transmit MIMO processor, a transmit processor, a controller/processor, a memory, or a combination thereof, of the UE described above in connection with FIG. 2.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of ” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A method of wireless communication performed by a first user equipment (UE), comprising:
transmitting, to a second UE, an indication of a discontinuous reception paging cycle and a wake up signal time offset value; and
transmitting, to the second UE, a wake up signal based at least in part on the discontinuous reception paging cycle and the wake up signal time offset value.

2. The method of claim 1, wherein the discontinuous reception paging cycle includes one or more paging occasions, and the wake up signal time offset value indicates a time offset for a wake up signal occasion prior to each paging occasion.

3. The method of claim 1, wherein transmitting, to the second UE, a wake up signal based at least in part on the discontinuous reception paging cycle and the wake up signal time offset value comprises:
transmitting the wake up signal using beam sweeping in a plurality of beam directions.

4. The method of claim 1, transmitting, to the second UE, the wake up signal based at least in part on the discontinuous reception paging cycle and the wake up signal time offset value comprises:
transmitting the wake up signal in a wake up signal occasion preceding a paging occasion in the discontinuous reception paging cycle based at least in part on the wake up signal offset value.

5. The method of claim 1, further comprising:
transmitting, to the second UE, a paging message based at least in part on transmitting the wake up signal.

6. The method of claim 5, wherein transmitting, to the second UE, the paging message based at least in part on transmitting the wake up signal comprises:
transmitting the paging message in a paging occasion in the discontinuous reception paging cycle subsequent to transmitting the wake up signal, based at least in part on the wake up signal time offset value.

7. The method of claim 5, wherein transmitting, to the second UE, the paging message based at least in part on transmitting the wake up signal comprises:
transmitting the paging message using beam sweeping in a plurality of beam directions.

8. The method of claim 5, wherein the paging message is included in a physical control channel communication.

9. The method of claim 1, wherein transmitting the wake up signal comprises:
transmitting the wake up signal to the second UE while the second UE is in at least one of an idle mode or an inactive mode.

10. A method of wireless communication performed by a second user equipment (UE), comprising:
receiving, from a first UE, an indication of a discontinuous reception paging cycle and a wake up signal time offset value; and
receiving, from the first UE, a wake up signal based at least in part on the discontinuous reception paging cycle and the wake up signal time offset value.

11. The method of claim 10, wherein the discontinuous reception paging cycle includes one or more paging occasions, and the wake up signal time offset value indicates a time offset for a wake up signal occasion prior to each paging occasion.

12. The method of claim 10, wherein the wake up signal is transmitted using beam sweeping in a plurality of beam directions.

13. The method of claim 10, receiving, from the first UE, the wake up signal based at least in part on the discontinuous reception paging cycle and the wake up signal time offset value comprises:
monitoring a wake up signal occasion preceding a paging occasion in the discontinuous reception paging cycle based at least in part on the wake up signal offset value; and
receiving, from the first UE, the wake up signal in the wake up signal occasion.

14. The method of claim 13, wherein monitoring the wake up signal occasion comprises:
activating from a sleep state to monitor the wake up signal occasion.

15. The method of claim 13, further comprising:
monitoring the paging occasion subsequent to the wake up signal occasion based at least in part on receiving the wake up signal in the wake up signal occasion.

16. The method of claim 15, further comprising:
receiving, from the first UE, a paging message in the paging occasion subsequent to the wake up signal occasion.

17. The method of claim 16, wherein the paging message is transmitted using beam sweeping in a plurality of beam directions.

18. The method of claim 16, wherein the paging message is included in a physical control channel communication.

19. The method of claim 16, further comprising:
switching from one of an idle mode or an inactive mode to a connected mode based at least in part on receiving the paging message.

20. A first user equipment (UE) for wireless communication, comprising:
a memory; and
one or more processors operatively coupled to the memory, the memory and the one or more processors configured to:
transmit, to a second UE, an indication of a discontinuous reception paging cycle and a wake up signal time offset value; and
transmit, to the second UE, a wake up signal based at least in part on the discontinuous reception paging cycle and the wake up signal time offset value.

21. A second user equipment (UE) for wireless communication, comprising:
a memory; and
one or more processors operatively coupled to the memory, the memory and the one or more processors configured to:
receive, from a first UE, an indication of a discontinuous reception paging cycle and a wake up signal time offset value; and
receive, from the first UE, a wake up signal based at least in part on the discontinuous reception paging cycle and the wake up signal time offset value.

22-26. (canceled)
